(19) United States
(12) Patent Application Publication
(10) Pub. No.: US 2025/0388273 A1
(43) Pub. Date: Dec. 25, 2025

(54) ANGLED BED CAP FOR TRUCK

(71) Applicant: FCA US LLC, Auburn Hills, MI (US)

(72) Inventors: Arturo Guzman-Magana, Auburn Hills, MI (US); Jonathan M. Francis, Auburn Hills, MI (US); Samarsingham Jeyasingham, Auburn Hills, MI (US); Shawn M. Miller, Auburn Hills, MI (US); Gregory J. Fadler, Auburn Hills, MI (US)

(21) Appl. No.: 18/750,191

(22) Filed: Jun. 21, 2024

(51) Int. Cl. B62D 33/04; B62D 33/027; B62D 35/00

(52) U.S. Cl. CPC B62D 33/04; B62D 33/027; B62D 35/007

(57) ABSTRACT

A pick-up truck cargo box has a bed, a pair of sidewalls, with two ends, extending from the bed, a front wall between the sidewalls at one end and a tailgate between the two sidewalls at the other end. A raisable panel in each sidewall. The raisable panels moving from a first retracted position, inside the sidewalls, to a second raised position, extending from the sidewalls. A cover is between the panels. The cover moves from a position substantially parallel to the bed, with the panels in a retracted position, to an angled position, with the panels in a raised position, providing improved aerodynamic characteristics.

### FIELD

The present disclosure relates to vehicles and, more particularly, to pick-up trucks with an angled bed cap.

### BACKGROUND

This section provides background information related to the present disclosure which is not necessarily prior art.

In pick-up trucks, aerodynamics can be improved by a combination of different bed cover shapes. Ordinarily, the aerodynamics are improved by an angled cover. However, the angled covers are generally added to the vehicle or are a separate part. Also, the angled cover may interfere with the use of the cargo box. Thus, it is desirable to have an angled cover on the cargo bed that does not interfere with the use of the cargo box.

The present disclosure provides an angled cover for a pick-up that does not interfere with the use of the cargo box. The cover is integrated into the vehicle and is not a separate or add-on part. The present disclosure provides for sidewalls extending from the cargo bed fenders which, in turn, raises a cover positioned on top of the bed.

### SUMMARY

This section provides a general summary of the disclosure, and is not a comprehensive disclosure of its full scope or all of its features.

According to a first embodiment of the present disclosure, a pick-up truck cargo bed comprises a bed with a pair of sidewalls that include two ends. The sidewalls extend from the bed. A front wall is positioned between the sidewalls at one end and a tailgate is positioned between the two sidewalls at another end. A raisable panel is in each sidewall. The raisable panels moves from a first retracted position, inside of the sidewalls, to a second raised position, extending from the sidewalls. A cover is positioned between the panels. The cover moves from a position substantially parallel to the bed, with the panels in a retracted position, to an angled position, with the panels in a raised position, providing improved aerodynamic characteristics. The panels can be moved manually or automatically between the raised and retracted positions. A frame assembly receives a side panel. The frame assembly moves the panels between the retracted and extended positions. An actuator is coupled with the frame assembly to move the frame assembly between positions. A front panel moves between a retracted position to a raisable position at the front end of the truck bed. The front panel lifts and supports the cover. A hinged spoiler is positioned on the cover. The tailgate functions in the panels retracted and raised positions. The panels do not interfere with the bed cargo space.

According to a second aspect of the disclosure, a pick-up truck comprises a truck bed including a bed with a pair of sidewalls that include two ends. The sidewalls extend from the bed. A front wall is positioned between the sidewalls at one end and a tailgate is positioned between the two sidewalls at another end. A raisable panel is in each sidewall. The raisable panels moves from a first retracted position, inside of the sidewalls, to a second raised position, extending from the sidewalls. A cover is positioned between the panels. The cover moves from a position substantially parallel to the bed, with the panels in a retracted position, to an angled position, with the panels in a raised position, providing improved aerodynamic characteristics. The panels can be moved manually or automatically between the raised and retracted positions. A frame assembly receives a side panel. The frame assembly moves the panels between the retracted and extended positions. An actuator is coupled with the frame assembly to move the frame assembly between positions. A front panel moves between a retracted position to a raisable position at the front end of the truck bed. The front panel lifts and supports the cover. A hinged spoiler is positioned on the cover. The tailgate functions in the panels retracted and raised positions. The panels do not interfere with the bed cargo space.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle with the angled bed cap in a retracted position.

FIG. 2 is a perspective view of the angled bed cap in a raised position.

FIG. 3 is a partial cross-section view of FIG. 1.

FIG. 4 is a perspective view of the bed with the cover removed.

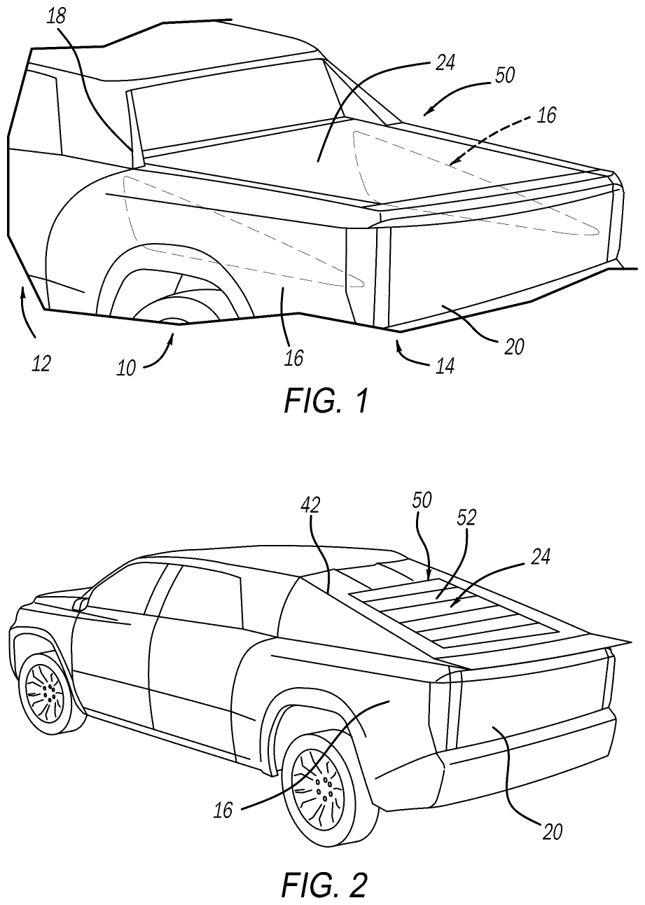

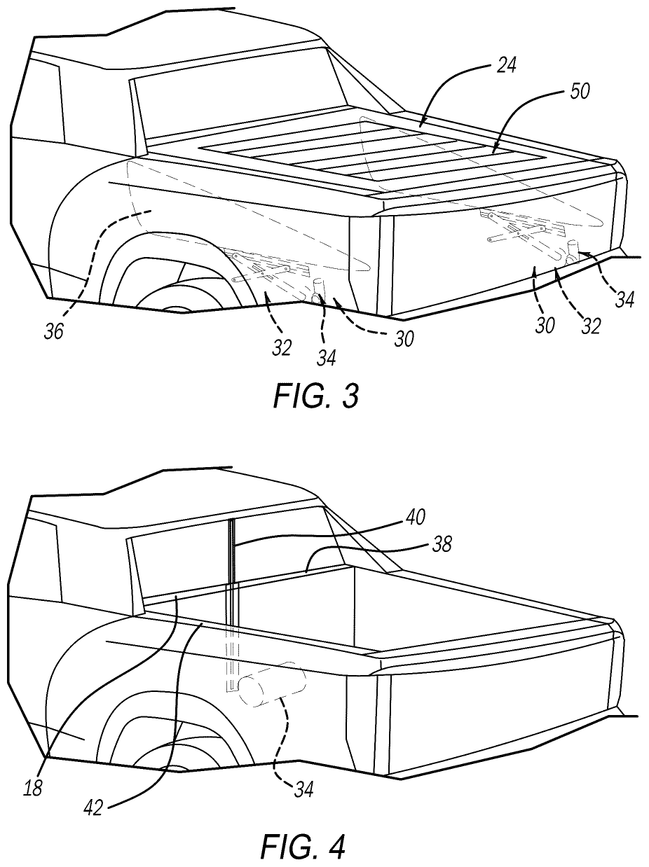

Corresponding reference numerals indicate corresponding parts throughout the several views of the drawings.

### DETAILED DESCRIPTION

Example embodiments will now be described more fully with reference to the accompanying drawings.

Turning to the figures, a vehicle, such as a pick-up truck, is illustrated and designated with the reference numeral 10. The pick-up truck 10 includes a cab 12 and a rear cargo box or bed 14. The cargo bed 14 includes sidewalls or fenders 16, a front wall 18 and a tailgate 20. The sidewalls 16, front wall 18 and tailgate 20 define the cargo space 22 inside of the sidewall 16, front wall 18 and tailgate 20. Also, a cover 24, such as tonneau cover, covers the cargo bed 14 to eliminate debris, weather or the like from entering into the cargo box 14.

Turning to FIG. 2, the pick-up truck 10 is illustrated with the cover 24 in an angled or raised position. The pick-up truck 10 includes an angled cap cover lift assembly 30. The lift assembly 30 moves the cover 24 from a position parallel to the truck bed to an angled position to the truck bed 14.

The lift assembly 30 includes a pair of frame assemblies 32 positioned with each one positioned in each sidewall 16. The frame assembly 32 is similar to frame assemblies that are utilized to raise windows in a vehicle door. The assembly 32 includes an actuator 34 that moves the frame assembly 32 from a retracted position to a raised position. A panel 36 is integrated with the frame assembly 32. The panel 36 moves through a gap in the sidewall or fender 16 to move from a retracted to a raised position as illustrated in FIG. 2. The panels 36 generally have a triangular or trapezoidal configuration to provide the angle from the angled cap cover 24.

Also, the assembly 30 includes a front panel 38. The front panel 38 is movable adjacent to or in the front wall 18 of the cargo bed 14. Generally, there is a center rail 40 that is coupled with the actuator 34 that automatically telescopes the front panel 38 to a raised position.

The cover 24 includes a rail system 42 that retains the side and front of the cover 24. Thus, as the panels 36, 38 are raised, the rail system 42 is raised from a position resting on the cargo bed sidewalls 16 to a position illustrated in FIG. 2 where the rails 42 are coupled with the panels 36,38 to move the cover 24 to a raised position. Thus, as the actuator 34 is activated, the frame assemblies 32, as well as the telescoping rail 40, move the panels 36, 38 from a retracted to a raised position. As the panels 36, 38 move to the raised position, the cover 24, positioned in the rails 42, is moved from the position parallel to the bed 14 to a position angled with respect to the bed 14 of the cargo box.

Also, a retractable spoiler 50 may be positioned on the cover 24. The spoiler 50 has a plurality of slats 52 to define the spoiler for increasing the aerodynamic characteristics. As the cover 24 is moved from a retracted position to a raised position, the spoiler slats 52 move from a flat position to an angled position enabling the air to be aerodynamically moved along the spoiler 50.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pick-up truck bed comprising:
a bed, a pair of sidewalls, with two ends, extending from the bed, a front wall between the sidewalls at one end and a tailgate between the two sidewalls at the other end;
a raisable panel in each sidewall, the raisable panels moving from a first retracted position inside the sidewalls to a second raised position extending from the sidewalls; and
a cover between the panels, the cover moving from a position substantially parallel to the bed with the panels in a retracted position to an angled position with the panels in a raised position providing improved aerodynamic characteristics.

2. The pick-up truck bed of claim 1, wherein the panels can be moved manually or automated between position.

3. The pick-up truck bed of claim 1, wherein a frame assembly receives a side panel, the frame assembly moving the panels between positions.

4. The pick-up truck bed of claim 3, wherein an actuator is coupled with the frame assembly for moving the frame assembly.

5. The pick-up truck bed of claim 1, wherein a front panel moves from a retracted position to a raisable position at the front end of the truck bed.

6. The pick-up truck bed of claim 5, wherein the front panel lifts and supports the cover.

7. The pick-up truck bed of claim 1, further comprising a hinged spoiler.

8. The pick-up truck bed of claim 1, wherein the tailgate functions in the panels retracted and raised positions.

9. The pick-up truck bed of claim 1, wherein the panels do not interfere with the bed cargo space.

10. A pick-up truck comprising:
a cargo space defining a bed, a pair of sidewalls, with two ends, extending from the bed, a front wall between the sidewalls at one end and a tailgate between the two sidewalls at the other end;
a raisable panel in each sidewall, the raisable panels moving from a first retracted position inside the sidewalls to a second raised position extending from the sidewalls; and
a cover between the panels, the cover moving from a position substantially parallel to the bed with the panels in a retracted position to an angled position with the panels in a raised position providing improved aerodynamic characteristics.

11. The pick-up truck of claim 10, wherein the panels can be moved manually or automated between position.

12. The pick-up truck of claim 10, wherein a frame assembly receives a side panel, the frame assembly moving the panels between positions.

13. The pick-up truck of claim 12, wherein an actuator is coupled with the frame assembly for moving the frame assembly.

14. The pick-up truck of claim 10, wherein a front panel moves from a retracted position to a raisable position at the front end of the truck bed.

15. The pick-up truck of claim 14, wherein the front panel lifts and supports the cover.

16. The pick-up truck of claim 10, further comprising a hinged spoiler.

17. The pick-up truck of claim 10, wherein the tailgate functions in the panels retracted and raised positions.

18. The pick-up truck of claim 10, wherein the panels do not interfere with the bed cargo space.
